(19) United States
(12) Patent Application Publication
(10) Pub. No.: US 2005/0063551 A1
(43) Pub. Date: Mar. 24, 2005

(54) Multi-channel surround sound expansion method

(76) Inventors: Yiou-Wen Cheng, Shu Lin City (TW); Mei-Chun Ku, Tai Chung Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/665,315

(22) Filed: Sep. 18, 2003

(51) Int. Cl. H04R 5/00; H04R 5/02

(52) U.S. Cl. 381/18; 381/19; 381/307

(57) ABSTRACT

A multi-channel surround sound expansion method is proposed. First, a two-channel stereo sound is read and then expanded into a Front L channel, a Front R channel, a Front M channel, a Rear L channel and a Rear R channel sound signals by means of the Hafler technique. Next, the sound reverberation technique is used to let the Rear L channel and Rear R channel sound signals generate sound with echo/reverberation. Finally, the Rear L channel and Rear R channel sound signals are delayed by a first time value, and the Front M channel sound signal is advanced by a second time value to emphasize the front sound field and the human voices, thereby producing a 3D sound field surrounding a listener.

### FIELD OF THE INVENTION

The present invention relates to a multi-channel surround sound expansion method and, more particularly, to a method making use of the Hafler technique, the audio filtering technique and the sound reverberation technique to expand stereo sounds into multi-channel surround sounds.

### BACKGROUND OF THE INVENTION

Along with progress of the information and computer technology, the entertainment and computation effects of electronic products have been continually enhanced due to the trend of compactness, multi-functionality, and high speed. Because of recent popularity of DVD players, DVD multi-channel home theater play systems can be realized in personal computers (PCs). It is only necessary to install a multi-channel sound card in a PC to play AC3 outputs of 5.1 channels from a DVD disc.

The computational capability of existent PCs affords smooth playing of a DVD with software. The outputs of 5.1 channels can be divided into six sound fields including a front left (Front L) channel, a front right (Front R) channel, a rear left (Rear L) channel, a rear right (Rear R) channel, a middle (M) channel and a super base channel. However, not all video media (e.g., VCD) provide outputs on 5.1 channels. In order to drive multi-channel loudspeakers, common two-channel stereo sound signals are mixed or copied to the multi-channel loudspeakers. There is no surround sound function. Therefore, there are sound cards making use of 3D sound positioning techniques like the head related transfer function (HRTF) technique to compare phases in the original two-channel sound signals, separate sounds in different directions, and duplicate sounds that can deceive human ears by means of DSP technique matched with special mixing and decoding functions. However, using the HRTF technique involves the problem of premium, in that an authorization fee must be paid for use of the HTRF library. Moreover, the HTRF technique needs to use special sound chips. Therefore, high-end sound cards having more than 4 channels are expensive.

In conventional audio amplifiers, the Hafler technique is generally used. The principle of the Hafler technique is disclosed in U.S. Pat. No. 3,697,692, wherein original two-channel (a left channel L and a right channel R) stereo sound signals are used to simulate sound outputs of 4 or 5 channels. That is, a rear left (L−R), a rear right (R−L), and a front middle (L+R)/2 channels are added. The Hafler technique is a very practical technique for producing surround sound in conventional audio amplifiers.

In the conventional audio amplifiers, using hardware to realize surround sound does not cause any problems. However, if a PC makes use of the Hafler technique or audio filtering technique with software, a situation where the rear left and rear right channels have no sound output may occur. This is because if the sound signals of the left and right channels are the same, (L−R) and (R−L) allows the signals of the left and right channels to cancel each other out. Therefore, the Hafler technique and audio filtering technique are generally not used in PCs.

### SUMMARY OF THE INVENTION

The primary object of the present invention is to provide a multi-channel surround sound expansion method. First, a two-channel stereo sound is read and then expanded into a Front L channel, a Front R channel, a Front M channel, a Rear L channel and a Rear R channel sound signals for output by means of the Hafler technique. Next, the sound reverberation technique is used to let the Rear L channel and Rear R channel sound signals generate sound with echo/reverberation. Finally, the Rear L channel and Rear R channel sound signals are delayed by a first time value, and the Front M channel sound signal is advanced by a second time value to emphasize the front sound field and the human voices, thereby producing a 3D sound field surrounding a listener.

Another object of the present invention is to provide a multi-channel surround sound expansion method, in which high-frequency instrument components and voice components are separated by means of audio filtering technique. Low-frequency components of the Front L channel and Front R channel sound signals are filtered out through a high-pass filtering operation. High-frequency instrument components of the Front M channel sound signal are filtered out through a low-pass filtering operation. High-frequency components of the Rear L channel and Rear R channel sound signals are also filtered out through a low-pass filtering operation. Therefore, different instrument sounds in the sound signal can be separated to emphasize the front sound field and the human voices, thereby producing a 3D sound field surrounding a listener.

Yet another object of the present invention is to provide a multi-channel surround sound expansion method, in which the left sound signal minus the right sound signal (L−R) is output to the Front L channel, the right sound signal minus the left sound signal (R−L) is output to the Front R channel, the left sound signal (L) is output to the Rear L channel, the right sound signal (R) is output to the Rear R channel, and the mean of the left sound signal and the right sound signal (L+R)/2 is output to the Front M channel. Through this arrangement, high-frequency instrument sound components can be emphasized behind or at the left and right sides of a listener instead of in front of him, hence building another sound field surrounding the listener.

### BRIEF DESCRIPTION OF THE DRAWINGS

The various objects and advantages of the present invention will be more readily understood from the following detailed description when read in conjunction with the appended drawing, in which:

FIG. 1 is a system architecture diagram of the present invention;

FIG. 2 shows a multi-channel sound expansion flowchart of the present invention;

FIG. 3 is a diagram showing arrangement positions of 5 channels of the present invention;

FIG. 4 is an architecture diagram of a feedback delay network (FDN) of the present invention;

FIG. 5 is a diagram showing the sound filtering characteristic of each channel of the present invention; and

FIG. 6 is a diagram showing surround sound arrangements and sound filtering characteristics according to a second embodiment of the present invention.

### DETAILED DESCRIPTION OF THE PREFERRED EMBODIMENTS

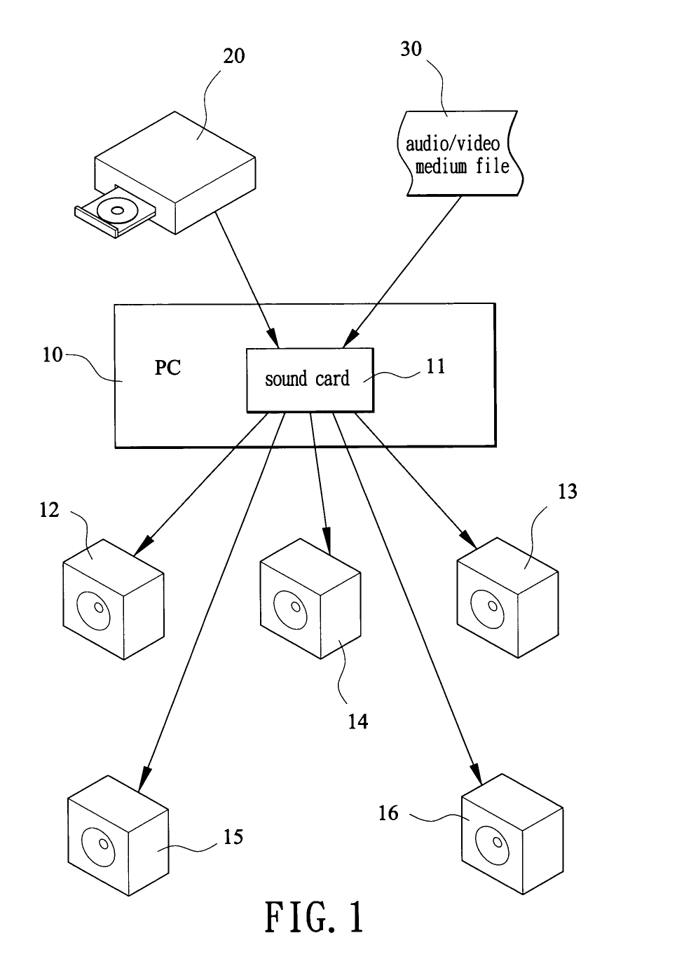

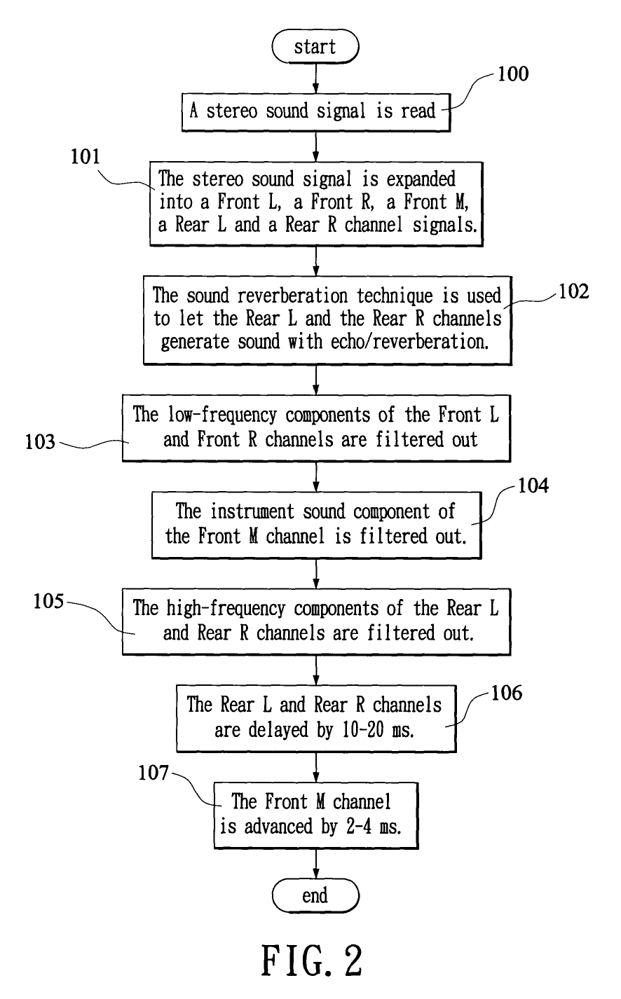

As shown in FIGS. 1 and 2, the present invention mainly applies to a personal computer (PC) 10, and can expand two-channel stereo sounds into multi-channel surround sounds when playing video media. A compact disc (CD) play medium 20 for playing VCD or DVD discs is generally installed on the PC 10. Alternatively, the PC 10 can play an audio/video media file 30 in WAV, MIDI, AUD, MP3 or MPEG format using a video play software. The present invention can also simulate several kinds of surround sound modes when playing audio/video media, to be selected by the user.

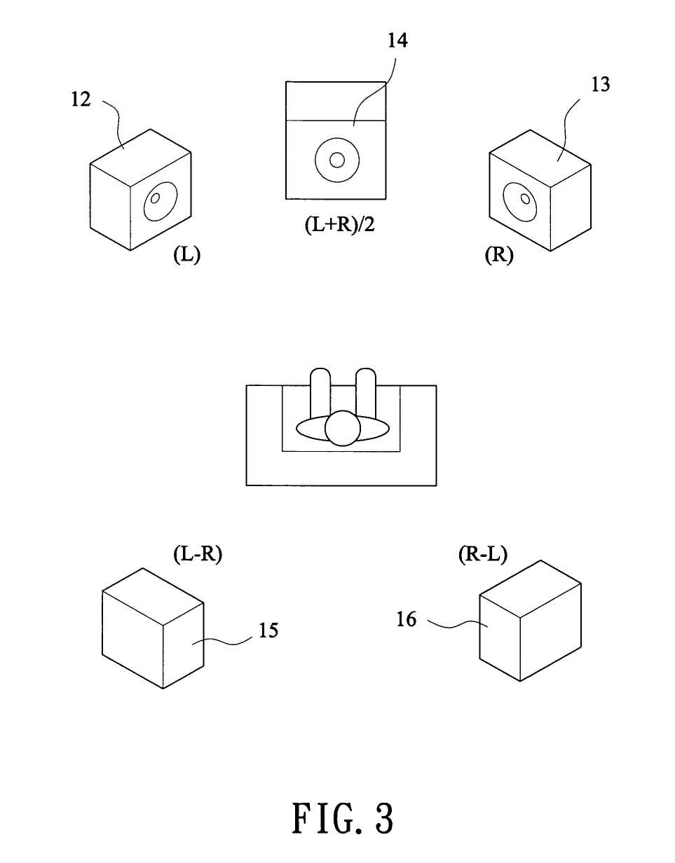

When the present invention is applied to the PC 10, it is necessary to install a multi-channel sound card 11 on the PC 10. The multi-channel sound card 11 can output to several loudspeakers like 4.1, 5.1, 6.1, 8.1 or more channels. The present invention uses an audio/video play software to expand the original two-channel stereo sounds into multi-channel surround sounds. In this embodiment, the method is exemplified with 5 channels shown in FIG. 3. Using the central position where a listener is located as the datum point, the five channels include a front left (Front L) channel 12, a front right (Front R) channel 13, a front middle (Front M) channel 14, a rear left (Rear L) channel 15 and a rear right (Rear R) channel 16.

In the present invention, a stereo sound signal is first read from an audio/video medium like a VCD disc 20 or an MP3 file 30 (Step 100). The stereo sound signal includes a left sound signal (L) and a right sound signal (R). The Hafler technique is used to expand the stereo sound signal into sound signals of 5 channels (Step 101). In other words, the left sound signal (L) is output to the Front L channel 12, the right sound signal (R) is output to the Front R channel 13, the mean of the left sound signal and the right sound signal (L+R)/2 is output to the Front M channel 14, the left sound signal minus the right sound signal (L−R) is output to the Rear L channel 15, and the right sound signal minus the left sound signal (R−L) is output to the Rear R channel 16. A sound reverberation operation is performed to sound signals of the Front L channel and the Front R channel or the Rear L channel and the Rear R channel to generate sound with echo/reverberationThe Rear L channel 15 and the Rear R channel 16 are generated by the difference of the left sound signal (L) and the right sound signal (R). If the left sound signal (L) and the right sound signal (R) are the same, the Rear L channel 15 and the Rear R channel 16 cancel each other out, thus producing no sound. Therefore, the present invention makes use of a sound reverberation technique whereby the Rear L channel 15 and the Rear R channel 16 undergo a sound reverberation operation and generate sound with reverberation (Step 102). The situation that the Rear L channel 15 and the Rear R channel 16 cancel each other can thus be avoided, hence accomplishing a wider listening space.

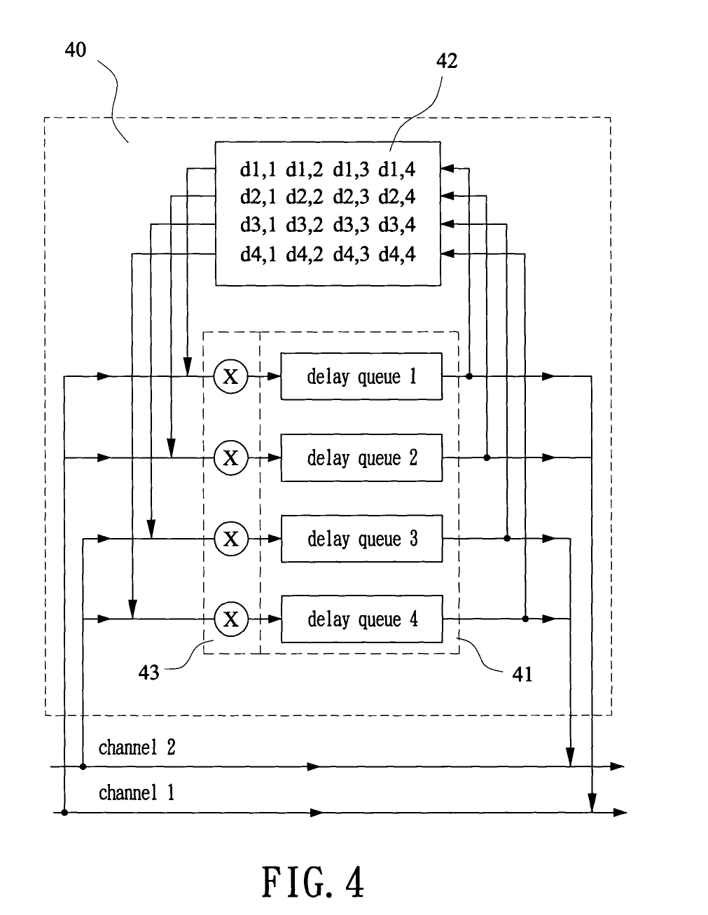

The sound reverberation operation makes use of a feedback delay networks (FDN) 40 shown in FIG. 4. The FDN technique provides two delay queues 41 and a queue matrix for each channel. The sound signal of the channel is delayed and then output to the delay queues 41 to generate two different delay signals. The delay time of each delay queue 41 is generated by setting a delay constant 43 for the delay queue 41. The delay times are different, and are set to be between about 2-10 ms. The delayed sound signal is then fed back to the input terminal of delay queue 41 via the queue matrix 42 and finally added into the sound signal to form a continually fed-back sound with reverberation. The delay queues 41 and the queue matrix 42 are generated through calculation with software.

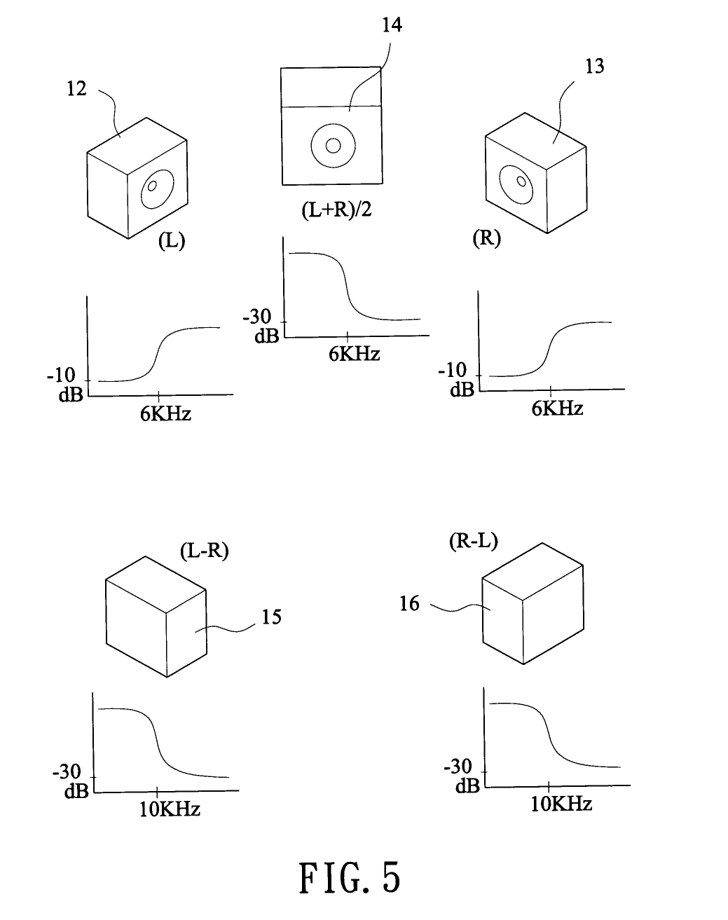

As shown in FIG. 5, in order to emphasize 3D on-field sound of each channel, different instrument sounds in the sound signal are separated. For instance, high-frequency instrument sounds are sent out by the Front L channel or the Front R channel, the voice is sent out by the Front M channel, and low-frequency instrument sounds are sent out by the Rear L channel or the Rear R channel. Therefore, low-frequency components of the Front L channel 12 and the Front R channel 13 are filtered out through a high-pass filtering operation (Step 103). The frequency response of this high-pass filtering operation is about −10 dB at 6 KHz.

The instrument sounds of the Front M channel 14 are filtered out through a low-pass filtering operation (Step 104). The frequency response of this low-pass filtering operation is about −30 dB at 6 KHz. High-frequency components of the Rear L channel 15 and the Rear R channel 16 are also filtered out through a low-pass filtering operation. The frequency response of this low-pass filtering operation is about −30 dB at 10 KHz. Various instrument sounds can thus be separated. The high-pass and low-pass filtering operations can be realized with software.

In order to emphasize instrument sounds and voices of the front channels, the sound signals of the Rear L channel 15 and the Rear R channel 16 are delayed by a first time value of about 10-20 ms (Step 106). The sound signal of the Front M channel 14 is advanced by a second time value of about 2-4 ms (Step 107). The 3D on-field sound field can thus be accomplished for a listener.

In addition, the multi-channel sounds of the present invention further comprise a super base channel to form 5.1 channels. The super base channel is the same as that in the prior art. A low-pass filtering operation is used to filter out high-frequency components of the left sound signal (L) and the right sound signal (R). The frequency response of this low-pass filtering operation is about −30 dB at 120 Hz. For 6.1 channels, a rear middle (Rear M) channel is added at the rear middle of a listener. The Rear M channel is the mean of the Real L channel 15 and the Rear R channel 16, i.e., (RL+RR)/2.

Moreover, 8.1 channels apply to a larger listening environment. A middle left (Middle L) channel and a middle right (Middle R) channel are added exactly at the left and right sides of the listener. The Middle L channel can be a copy of the Rear L channel, and the Middle R channel can be a copy of the Rear R channel. Similarly, more left channels and right channels can be added for an even larger listening environment to average the field volume of the whole listening environment.

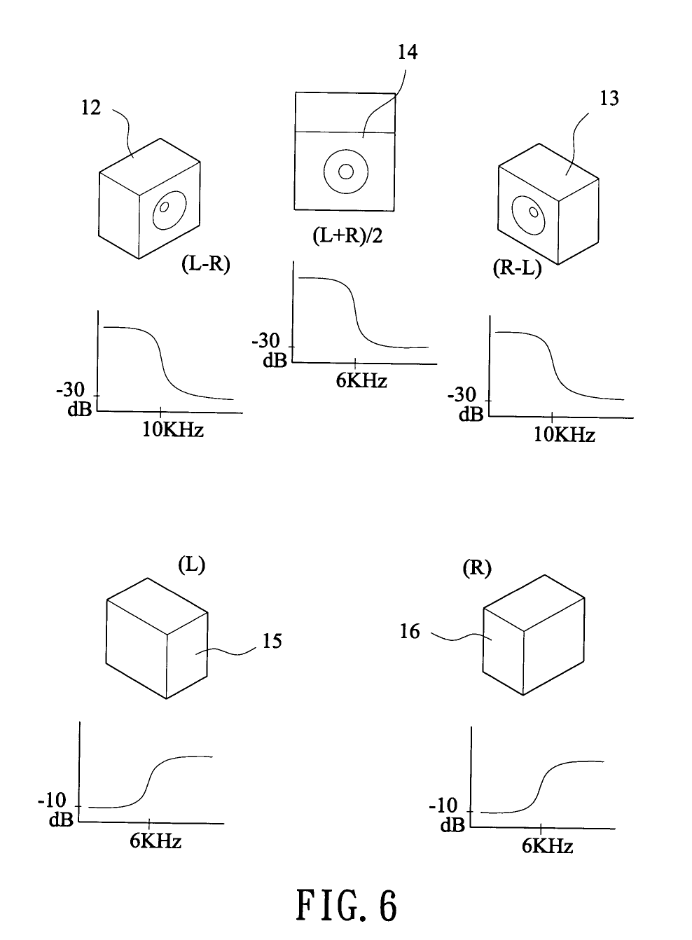

As shown in FIG. 6, the Hafler technique is similarly used to expand the stereo sound signal into 5-channel sound signals. The output mode, however, is different. The left sound signal minus the right sound signal (L−R) is output to the Front L channel 12, the right sound signal minus the left sound signal (R−L) is output to the Front R channel 13, the left sound signal (L) is output to the Rear L channel 15, the right sound signal (R) is output to the Rear R channel 16, and the mean of the left sound signal and the right sound signal (L+R)/2 is output to the Front M channel 14.

Similarly, in this embodiment, high-frequency components of the Front L channel 12 and the Front R channel 13 are filtered out through a low-pass filtering operation. The frequency response of this low-pass filtering operation is about −30 dB at 10 KHz. Low-frequency components of the Rear L channel 15 and the Rear R channel 16 are filtered out through a high-pass filtering operation. The frequency response of this high-pass filtering operation is about −10 dB at 6 KHz.

Similarly, in this embodiment, the sound signals of the Rear L channel 15 and the Rear R channel 16 are delayed by about 10-20 ms. The sound signal of the Front M channel 14 is advanced by about 2-4 ms. Through this arrangement, high-frequency instrument sounds can be emphasized behind the listener instead of in front of him, thereby producing a 3D sound field surrounding a listener. This is very suitable for situations such as a karaoke bar or private room setting.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A multi-channel surround sound expansion method comprising the steps of:
reading a stereo sound signal including a left sound signal and a right sound signal;
expanding said stereo sound signal into a Front L channel, a Front R channel, a Front M channel, a Rear L channel and a Rear R channel sound signals;
performing a sound reverberation operation on sound signals of said Front L channel and said Front R channel or said Rear L channel and said Rear R channel to generate sound with echo/reverberation;
delaying said Rear L channel and Rear R channel sound signals for a first time value; and
advancing said Front M channel sound signal for a second time value.

2. The multi-channel surround sound expansion method as claimed in claim 1, wherein said step of expanding said stereo sound signal into multi-channel sound signals is accomplished by using a Hafler technique to output said left sound signal directly to said Front L channel, output said right sound signal to said Front R channel, output said left sound signal minus said right sound signal to said Rear L channel, and output said right sound signal minus said left sound signal to said Rear R channel.

3. The multi-channel surround sound expansion method as claimed in claim 2, wherein said Front L channel and Front R channel sound signals are sound signals having low-frequency components filtered out through a high-pass filtering operation.

4. The multi-channel surround sound expansion method as claimed in claim 3, wherein the frequency response of said high-pass filtering operation is about −10 dB at 6 KHz.

5. The multi-channel surround sound expansion method as claimed in claim 2, wherein said Front M channel sound signal is a sound signal having high-frequency components filtered out through a low-pass filtering operation.

6. The multi-channel surround sound expansion method as claimed in claim 5, wherein the frequency response of said low-pass filtering operation is about −30 dB at 6 KHz.

7. The multi-channel surround sound expansion method as claimed in claim 2, wherein said Rear L channel and Rear R channel sound signals are sound signals having high-frequency components filtered out through a low-pass filtering operation.

8. The multi-channel surround sound expansion method as claimed in claim 7, wherein the frequency response of said low-pass filtering operation is about −30 dB at 10 KHz.

9. The multi-channel surround sound expansion method as claimed in claim 1, wherein said step of expanding said stereo sound signal into multi-channel sound signals is accomplished by a Hafler technique to directly output said left sound signal minus said right sound signal to said Front L channel, output said right sound signal minus said left sound signal to said Front R channel, output said left sound signal to said Rear L channel, and output said right sound signal to said Rear R channel.

10. The multi-channel surround sound expansion method as claimed in claim 9, wherein said Front L channel and Front R channel sound signals are sound signals having high-frequency components filtered out through a low-pass filtering operation.

11. The multi-channel surround sound expansion method as claimed in claim 10, wherein the frequency response of said low-pass filtering operation is about −30 dB at 10 KHz.

12. The multi-channel surround sound expansion method as claimed in claim 9, wherein said Front M channel sound signal is a sound signal whose high-frequency components are filtered out through a low-pass filtering operation.

13. The multi-channel surround sound expansion method as claimed in claim 12, wherein the frequency response of said low-pass filtering operation is about −30 dB at 6 KHz.

14. The multi-channel surround sound expansion method as claimed in claim 9, wherein said Rear L channel and Rear R channel sound signals are sound signals having low-frequency components filtered out through a high-pass filtering operation.

15. The multi-channel surround sound expansion method as claimed in claim 14, wherein the frequency response of said high-pass filtering operation is about −10 dB at 6 KHz.

16. The multi-channel surround sound expansion method as claimed in claim 1, wherein said multi-channel sound signals further include a super bass channel sound signal.

17. The multi-channel surround sound expansion method as claimed in claim 16, wherein said super base channel sound signal is obtained by using at least a low-pass filtering operation to filter out high-frequency components of said left sound signal and said right sound channel.

18. The multi-channel surround sound expansion method as claimed in claim 1, wherein said Front M channel sound signal is a mean of said left sound signal and said right sound signal.

19. The multi-channel surround sound expansion method as claimed in claim 1, wherein said multi-channel sound signals further include a Rear M channel sound signal.

20. The multi-channel surround sound expansion method as claimed in claim 19, wherein said Rear M channel sound signal is a mean of said Rear L channel and Rear R channel sound signals.

21. The multi-channel surround sound expansion method as claimed in claim 1, wherein said multi-channel sound signals further include at least a Middle L channel sound signal and at least a Middle R channel sound signal.

22. The multi-channel surround sound expansion method as claimed in claim 21, wherein said Middle L channel sound signal is a copy of said Rear L channel sound signal, and said Middle R channel sound signal is a copy of said Rear R channel sound signal.

23. The multi-channel surround sound expansion method as claimed in claim 1, wherein said first time value is between about 10 and 20 ms.

24. The multi-channel surround sound expansion method as claimed in claim 1, wherein said second time value is between about 2 and 4 ms.

25. The multi-channel surround sound expansion method as claimed in claim 1, wherein said sound reverberation operation is accomplished through a feedback delay networks technique.

26. The multi-channel surround sound expansion method as claimed in claim 25, wherein a plurality of delay queues and a queue matrix are provided in said feedback delay networks technique, a channel sound signal is input into said delay queues to generate a plurality of delay signals fed back to said delay queues via said queue matrix, and said channel sound signal is finally added to said channel to form a continually fed-back sound with reverberation.

27. The multi-channel surround sound expansion method as claimed in claim 26, wherein said delay signals generated by said delay queues are obtained by setting a delay constant to said delay queues.

28. The multi-channel surround sound expansion method as claimed in claim 26, wherein delay times generated by said delay queues are different from one another.
